(19) United States
(12) Patent Application Publication
(10) Pub. No.: US 2024/0399354 A1
(43) Pub. Date: Dec. 5, 2024

(54) CATALYSTS

(71) Applicant: Board of Regents, The University of Texas System, Austin, TX (US)

(72) Inventors: Pawarat BOOTPAKDEETAM, Arlington, TX (US); Wilaiwan Chanmanee, Irving, TX (US); Brian H. Dennis, Austin, TX (US); Frederick M. Macdonnell, Austin, TX (US)

(21) Appl. No.: 18/732,262

(22) Filed: Jun. 3, 2024

Related U.S. Application Data
(60) Provisional application No. 63/470,415, filed on Jun. 1, 2023.

(51) Int. Cl. B01J 35/30; B01J 21/08; B01J 23/72; B01J 35/50; B01J 35/55; B01J 37/02; B01J 37/12

(52) U.S. Cl. CPC B01J 35/398; B01J 21/08; B01J 23/72; B01J 35/505; B01J 35/55; B01J 37/0213; B01J 37/12

(57) ABSTRACT

Two different types of catalysts are disclosed. The first catalyst has a porous support that is impregnated with an active metal catalyst. The support surrounds a metallic core, which functions to increase the bulk heat capacity of the catalyst, thereby damping temperature swings during use. The second catalyst also has a porous support that is impregnated with an active metal catalyst, which is heterogeneously distributed so that the catalyst is concentrated at or near the surface of the support structure. This is accomplished by impregnating the catalyst by pouring a molten metal catalyst over the bulk catalyst supports. This method allows of a small volume of molten catalyst relative to the pore volume of the support and concentrates the catalyst in a band near the surface of the supports.

### CROSS-REFERENCE TO RELATED APPLICATIONS

This application claims priority pursuant to 35 U.S.C. § 119 to U.S. Provisional Application Ser. No. 63/470,415, filed on Jun. 1, 2023, which is hereby incorporated by reference in its entirety.

### FIELD OF THE DISCLOSURE

The subject matter of the present disclosure refers generally to catalysts, and more particularly to catalysts having a heterogeneous distribution of active metals, as well as catalysts having a metallic core with a porous shell surrounding the core.

### BACKGROUND

Catalysts are commonly prepared by impregnating a porous support structure with one or more active metals. In the case of exothermic reactions, catalyst that is located deep within the interior of the support will be exposed to higher temperatures due to buildup of heat energy released by the reaction than catalyst located near the surface of the support, where heat can rapidly escape. This may result in a runaway temperature increase that can damage the support due to the resulting thermal stresses and also cause deactivation of the metal catalyst, thereby reducing efficiency and increasing catalyst costs. Further, the increase in temperature may cause the reaction to shift to undesirable products. For instance, in the case of Fischer-Tropsch synthesis (FTS) reactions, elevated temperatures generally result in the undesired products of methane and soot.

The performance of supported cobalt-based FTS catalysts have been enhanced by numerous techniques, including the use of catalyst promoters, support shape, and impregnation techniques, including “eggshell” catalysts in which a thin layer of metal is impregnated onto the support only at the outer surface of the support, as well as core-shell catalysts in which a shell surrounds an inner core, each of which has considerable influence on the thermal properties of the catalyst. In the case of an “eggshell” catalyst, many mass transport restrictions within a large catalyst pellet can be reduced, leading to a higher synthesis rate and C5+ selectivity and perhaps better temperature control of the reaction. Other catalyst production techniques include a cobalt on alumina core-shell (CS) support in which the support is made by partial oxidation of an aluminum powder via oxidation/corrosion with sodium hydroxide solution. These CS nanoparticle catalysts showed an increase in thermal conductivity over similarly prepared cobalt/alumina catalysts and better CO conversion and C5+ selectivities. Other catalyst production techniques have included a yolk/shell catalyst support from a high thermal conductive core-shell, but used phase change material to manage the heat from catalytic reactions. Both eggshell and core-shell catalysts generally have better mass-transfer properties as the catalytic reaction is constrained to a portion of the support containing active metal, thus minimizing differences in the intra particle diffusion rates of CO and resulting in an increase in C5+ selectivity. However, this comes with a proportional loss in catalyst loading.

### SUMMARY

In one aspect, a catalyst comprising a porous support surrounding a metallic core is provided. The support is impregnated with an active metal catalyst, such as cobalt and/or ruthenium. In a preferred embodiment, the support comprises porous silica or alumina, and the metallic core comprises a length of copper wire or rod. In this embodiment, the support may be in the form of a generally cylindrical pellet having an opening extending through the pellet along a longitudinal axis of the pellet. The copper wire may be securely installed within the elongated opening and cut at opposing ends of the wire so that an end portion of the wire is exposed at opposing ends of the pellet. The support may be impregnated with a metal catalyst using any suitable technique, such as incipient wet impregnation or the molten catalyst impregnation technique as described herein.

Compared to convention catalysts, this catalyst replaces the porous interior support with a solid material with high thermal conductivity and heat capacity, such as copper metal, which, in this case, may be a copper wire. Due to its high thermal capacity, the metal serves as a heat reservoir to either absorb or release heat according to the temperature in the outer layer where the reaction is occurring. This helps to avoid exposing the reaction layer to large temperature swings that may occur during changing flow conditions within the reactor. Thus, the ratio of metal mass to catalyst mass controls the degree of temperature damping.

In another aspect, a method of producing a catalyst having a heterogeneous distribution of active metal catalyst is provided. The catalyst comprises a support, which is preferably porous silica or alumina, that is impregnated with an active metal catalyst, such as cobalt and/or ruthenium. The metal catalyst is heterogeneously distributed within pores of the support so that there is a greater concentration of the active metal catalyst near the exterior surface of the support. The catalyst support preferably comprises a plurality of pellets, each of which may have a cylindrical shape or other suitable shape. Each pellet is porous but generally has an exterior surface. A molten form of the metal catalyst is then poured over the pellets to impregnate the catalyst support with active metal catalyst. In one preferred embodiment, the molten catalyst solution is an aqueous solution of cobalt nitrate hexahydrate.

Unlike a conventional incipient wet impregnation technique that uses a volume of solution having a volume that is approximately equal to the pore volume of the catalyst support and that is typically at room temperature, the present method utilizes a solution that is heated above room temperature and also utilizes a volume of solution that is substantially less than the volume used in incipient wet impregnation. In a preferred embodiment, the present method utilizes a volume of solution that is in the range of approximately 10% to 30% by volume of the volume of solution that would typically be utilized for an incipient wet impregnation process. The penetration depth of the solution into the catalyst support may be controlled by adjusting the viscosity of the molten catalyst solution. For instance, the viscosity may be decreased by adding water or increased by adding cellulose or a similar type of polymer in a solution. The present catalyst preparation method results in the active catalyst metals being concentrated in a narrow band at or just below the surface of the catalyst support.

In the case of exothermic reactions, the active catalyst being concentrated at or near the surface allows for heat produced by the reaction to escape from the catalyst support rapidly and efficiently, which will minimize buildup of heat energy within the catalyst support. By minimizing heat buildup, catalyst produced in accordance with the present method also minimizes catalyst deactivation, which reduces the amount of active metals required, thereby reducing the catalyst cost. In addition, by minimizing the temperature of the catalyst support, catalyst produced in accordance with the present method also minimizes the potential for damage to the catalyst support due to thermal stresses and minimizes undesirable products, such as methane and soot in the case of FTS reactions.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWING

These and other features, aspects, and advantages of the present disclosure will become better understood with regard to the following description, appended claims, and accompanying drawings where:

FIG. 1A shows unmodified catalysts supports in accordance with the present disclosure.

FIG. 1B shows modified catalysts supports in accordance with the present disclosure.

FIG. 2A shows catalysts in different stages of preparation in accordance with the present disclosure.

FIG. 2B shows catalysts in different stages of preparation in accordance with the present disclosure.

FIG. 2C shows catalysts in different stages of preparation in accordance with the present disclosure.

FIG. 3 shows a schematic diagram of a Fischer-Tropsch synthesis setup in accordance with the present disclosure.

FIG. 4 shows a schematic diagram of a copper tube with a heating element utilized in a reactor in accordance with the present disclosure.

FIG. 5A shows SEM images of unmodified catalyst supports in accordance with the present disclosure.

FIG. 5B shows SEM images of modified catalysts in accordance with the present disclosure.

FIG. 5C shows TEM images of unmodified catalyst supports in accordance with the present disclosure.

FIG. 5D shows TEM images of modified catalysts in accordance with the present disclosure.

FIG. 6A shows temperature profiles of reactor and a furnace used in a Fischer-Tropsch synthesis with conventional catalysts in accordance with the present disclosure.

FIG. 6B shows temperature profiles of reactor and a furnace used in a Fischer-Tropsch synthesis with modified catalysts in accordance with the present disclosure.

FIG. 7 shows the geometry of a modified core-shell catalyst in accordance with the present disclosure.

FIG. 8 shows a graph illustrating the results of a temperature profile simulation of conventional and modified catalysts in accordance with the present disclosure.

FIG. 9A shows optical micrographs of silica pellets impregnated in cobalt-ruthenium solution in accordance with the present disclosure.

FIG. 9B shows optical micrographs of silica pellets impregnated in cobalt-ruthenium solution in accordance with the present disclosure.

FIG. 9C shows optical micrographs of silica pellets impregnated in cobalt-ruthenium solution in accordance with the present disclosure.

FIG. 9D shows optical micrographs of silica pellets impregnated in cobalt-ruthenium solution in accordance with the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

### Core-Shell Catalyst

In one aspect, a catalyst comprising a porous support surrounding a metallic core is provided. The support is impregnated with an active metal catalyst, such as cobalt (Co) and/or ruthenium (Ru). In alternative embodiments, other metal catalyst may be utilized in addition to or in place of cobalt and/or ruthenium, including, but not limited to, iron (Fe) or nickel (Ni). In a preferred embodiment, the support comprises porous silicon dioxide (SiO₂) or alumina (Al₂O₃). In other embodiments, the support may comprise other suitable types of catalyst support structures, including, but not limited to, zirconia (ZrO₂), silicon carbide (SiC), or other porous structures suitable for use as a catalyst support. In a preferred embodiment, the metallic core comprises a length of copper (Cu) wire or rod. In this embodiment, the support may be in the form of a generally cylindrical pellet having an opening extending through the pellet along a longitudinal axis of the pellet. The copper wire may be securely installed within the elongated opening and cut at opposing ends of the wire so that an end portion of the wire is exposed at opposing ends of the pellet. In alternative embodiments, the core of the catalyst support structure may comprise other metallic structures, such as an aluminum (Al) core. In other embodiments, the support may have other shapes that allow for a core to be installed within the support structure, including, but not limited to, an ellipsoidal or cuboidal shape. In a preferred embodiment, the catalyst support has at least one opening designed so that a portion of the core structure is exposed from an exterior of the support structure, and preferably two openings at opposing ends of the catalyst support so that the core structure is exposed from the exterior of the support structure at both ends, though in other embodiments the core structure may be entirely surrounded by the support structure. The support may be impregnated with a metal catalyst using any suitable technique, such as incipient wet impregnation, a molten catalyst impregnation technique as described herein, or other suitable impregnation techniques.

### Catalyst Preparation

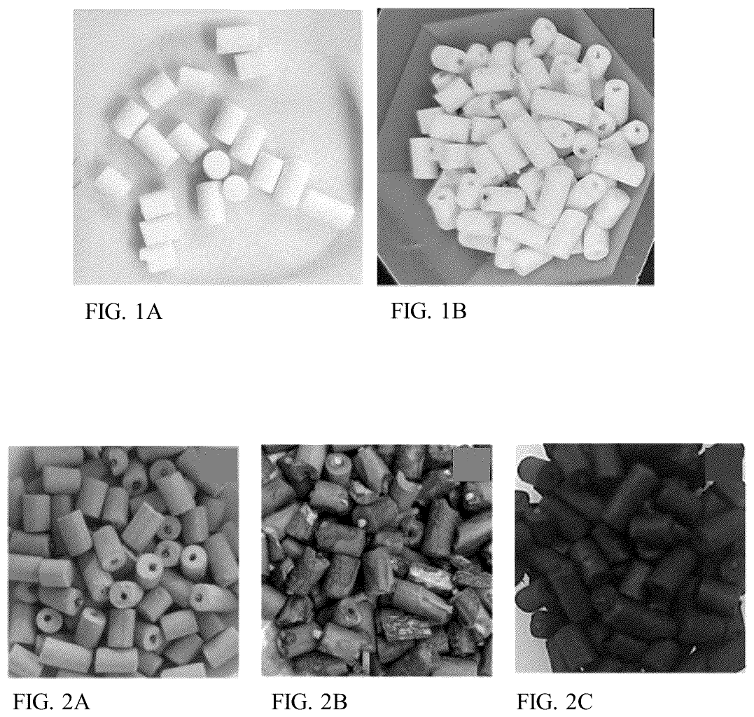

To test the effectiveness of the present catalyst, the catalyst was first prepared in accordance with the present catalyst production method and then utilized in a Fischer-Tropsch synthesis (FTS) reaction system. First, a modified catalyst support was made from a conventional catalyst support that is commercially available. In this case, the conventional catalyst support was a silica support comprising cylindrical high surface area silica pellets(S), which are shown in FIG. 1(a). The pellets utilized are 3 mm (millimeters) in diameter with lengths ranging from 3 to 6 mm. The pellets have a surface area of 210 m²/g (square meters per gram) and a pore volume of 1.1 cm³/g (cubic centimeters per gram). Axially oriented holes were drilled into individual silica pellet cylinders using a drill press with a 1 mm bit. The hole drilled in each cylindrical pellet extended the entire longitudinal length of the pellet so that the pellet had openings at two opposing ends of the pellet. The hole in each cylindrical pellet was then filled with a length of copper rod having a diameter of approximately 1 mm so that the rod fit tightly within the drilled opening. The copper rod was cut to have approximately the same length as the pellet so that opposing ends of the rod were exposed at opposing ends of the pellet and were generally flush with the openings at the opposing ends of the pellet. FIG. 1(b) illustrates a plurality of composite core-shell catalyst supports with copper rods installed within the cylindrical silica pellets. This produces an approximate core-shell arrangement with the core consisting of a material with good thermal conductance and heat capacity.

After producing the core-shell support, a control (CT) catalyst support (a cylindrical silica pellet without a drilled opening or metal core) and the core-shell (CS) catalyst support were prepared as catalysts by an incipient wet impregnation method (IWI) to deposit catalyst particles on the silica shell of the support structure. The pellets were first impregnated with an aqueous solution of cobalt nitrate (Co(NO₃)₂·6H₂O) to give a 16% by mass cobalt metal on the silica support. CS supports were 84% by mass silica and the cobalt loading was also fixed at 16% Co per unit mass of silica. After the pellets were loaded to incipient wetness, the pellets were placed in an oven at 90° C. for 18 hours to remove most of the water. The pre-catalyst at this stage is shown in FIG. 2(a). The dry catalyst support was next impregnated with an aqueous solution of ruthenium chloride (RuCl₃·xH₂O) to give a loading of 1.5% mass percent of Ru metal (based on silica mass). The pellets were then dried in an oven at 90° C. for 18 hours, yielding the pre-catalysts shown in FIG. 2(b).

The last step prior to reduction was calcining the pellets at 350° C. for approximately 6 hours, which produced the catalyst shown in FIG. 2(c). After the pre-catalyst (16 wt % Co, 1.5 wt % Ru/SiO₂ modified catalyst support) was completely dried, the pre-catalyst was calcined in a temperature-programmed oven with the following temperature profile:

| | |
|---|---|
| Temperature _{Room}-Temperature _{120°} _{C.} | Ramping 10° C./minute |
| Temperature _{120°} _{C.}-Temperature _{200°} _{C.} | Ramping 5° C./minute |
| Temperature _{200°} _{C.}-Temperature _{350°} _{C.} | Ramping 2° C./minute |
| Temperature _{350°} _{C.} | Hold for 5.5 hours |
| Temperature _{350°} _{C.}-Temperature _{Room} | Ramping −1° C./minute |

### Catalyst Reduction, Activation, and Synthesis Conditions

An FTS run was performed in a tubular fixed bed reactor to test the catalytic performance of the CT and CS-Cu (core-shell with a copper core) catalysts, which were compared under identical synthesis conditions. Additional runs under the same conditions were later performed utilizing silica supports with an alumina core, two different sizes of a graphite core, and also a hollow core. The results are shown in Table 4 below.

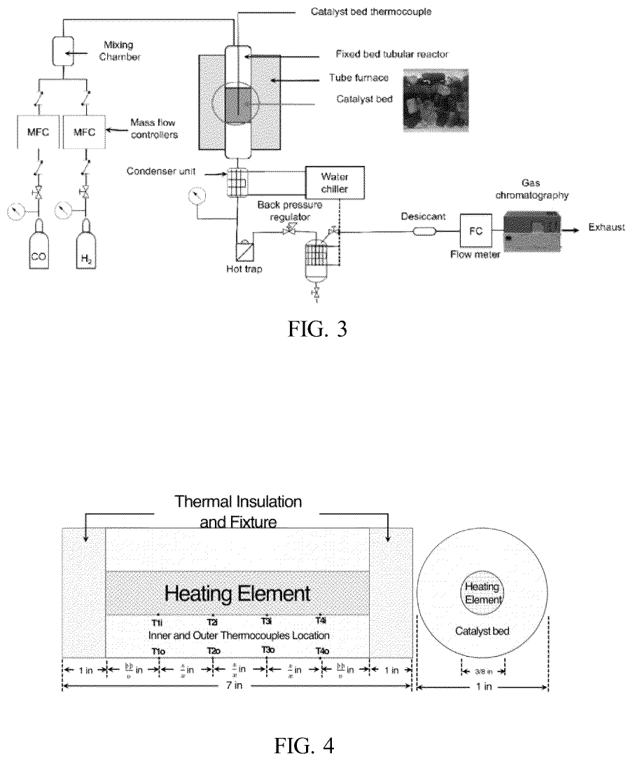

The tubular fixed bed reactor used for the experiments was made of 316 stainless steel with a ⅜″ (9.5 mm) inside diameter. The reactor was packed with a diluted catalyst with the ratio of 2 grams of catalyst per 2.76 grams of quartz chips. The catalyst bed was held by stainless steel wool at both ends in order to keep the catalyst in the hottest zone of the oven. A tube furnace was used as the heating element in this synthesis. The temperature of the furnace was controlled by a PID (proportional-integral-derivative) controller. The top part of the reactor was connected to the feed line, which delivered a gas mixture of hydrogen (H₂) and carbon monoxide (CO) as shown in FIG. 3 illustrating the Fischer-Tropsch synthesis system. The amount of gas from feed lines for each feed gas was controlled by a mass flow controller (MFC). The amount of gas flow was calculated according to the molar gas ratio (2 moles of H₂ to 1 mole of CO) and the desired flow rate, for example, 100 sccm (standard cubic centimeters per minute). The gases were pre-mixed in a mixing chamber at the outlet of the MFC before being fed to the top of the reactor. A single point J-type thermocouple for measuring reaction temperature was inserted into a tee that connected the feed line and reactor, which was used to monitor temperature changes in the catalyst bed. The bottom of the reactor was connected to a water chill condenser, a back pressure regulator (BPR), and a glass graduated collection flask (GGCF) that functioned as a liquid collector. The gas-liquid mixture produced during the synthesis was output from the reactor into a hot trap and then through the BPR, which was used to drop the pressure of the gas-liquid mixture from about 300 psig to 0 psig, and the liquids were collected in the GGCF (kept in an ice batch). The exiting gas then passed through a chilled water condenser above the GGCF to strip out any remaining condensables, which dropped into the GGCF. The gas exiting the condenser was passed though a desiccant bed and then a flowmeter to record the gas output. The output gas was periodically sampled by gas chromatography, which gave the CO, H₂, CH₄ (methane), CO₂ (carbon dioxide), C₂H₂ (acetylene), C₂H₄ (ethylene), and C₂H₆ (ethane) composition of exhausted gas. Only CO, H₂, CH₄, and CO₂ were quantified. A schematic diagram of the system is shown in FIG. 3.

FIG. 4 shows a schematic diagram of a 1″ diameter copper tube with a ⅜″ diameter heating element disposed axially at the center of the tube. This setup was utilized to conduct a bulk thermal conductivity analysis on the catalyst. The temperature difference between the heating element surface and the copper tube wall was measured at different locations using thermocouples while the catalyst supports were packed inside the catalyst bed located in between the copper tube and heating element. The insulation and the fixtures sealed the copper tube at both ends in order to fix the catalyst bed in place and allow radial heat transfer to happen via the catalyst. The temperature difference between the surface of the heating element and the copper tube were monitored using K-type thermocouples and recorded. The bulk thermal conductivity was interpreted from the relationship between heat flow and the temperature field using Fourier's law.

A series of FTS runs were performed in the tubular fixed bed reactor packed with 2 grams by weight or 8.6 cm³ by volume of the pre-catalyst and 2.76 grams by weight or 4.1 cm³ by volume of the quartz chips diluent. The pre-catalyst was then reduced in situ at 0 psig with a 100 sccm H₂ flow rate, in which the temperature of the reactor was gradually increased from room temperature to 400° C. and maintained at 400° C. for 18-20 hours. After the pre-catalyst was reduced, the reactor temperature was decreased from 400° C. to 150° C. and maintained at 150° C. while pressurizing the reactor with pure H₂ at a steady flow rate of 100 sccm. After the pressure reached the setpoint at 300 psig, the pure H₂ was switched to syngas by reducing the H₂ flow rate to 66.67 sccm as CO was being introduced into the system with a 33.33 sccm flow rate. The flow rate between H₂ and CO was kept constant at a ratio of 2:1. Once the flow rate between H₂ and CO was stabilized, the temperature was slowly increased (at a heating rate of 0.6° C./min) to 255° C., the activation temperature. The catalyst activation took about 6 hours to ramp up from 200° C. until the temperature reached the setpoint or synthesis temperature (255° C.). The temperature, inlet and outlet flow rate, and gas product activity were monitored and recorded during the synthesis.

Each FTS run was carried out for five days. Liquid products from the synthesis were collected in a graduated flask collector at 0 psig. The tail gas from the reactor outlet was analyzed using gas chromatography (GC) utilizing a thermal conductivity detector (TCD) with a capillary column after syngas was introduced into the system. The aqueous phase was analyzed once every 24 hours using gas chromatography-mass spectrometry (GC-MS) until the system was shut down.

### Pre-Catalyst and Catalyst Characterization

Surface area and pore volume of the supports, pre-catalysts, and catalysts were measured using the Brunauer-Emmet-Teller (BET) theory using a surface area and porosity analyzer. SEM (scanning electron microscope) and TEM (transmission electron microscopy) micrographs of the supports and catalysts were obtained. The catalyst pellets were required to be pretreated before observing using SEM because the catalyst pellet was made from non-conductive porous silica. The treatment was done using the sputtering process by coating a thin film conductive material such as carbon or silver at the catalyst surface to enhance the visibility of the SEM image by reducing the charge at the catalyst surface. TEM samples were powdered and suspended in isopropanol before deposition on the TEM grid by dipping in suspended solution.

The heat capacity of the CT and CS-Cu catalyst support was measured using differential scanning calorimetry (DSC). By using a temperature program, the catalyst supports were heated and cooled inside the DSC/TGA (thermal gravimetric analysis) chamber at 50 sccm N₂ flow rate and 300° C. maximum temperature. The process heat flow was used to determine heat capacity compared to the sapphire standard provided in the instrument calibration kit. Bulk thermal conductivity was measured on a home-build apparatus as shown in FIG. 4, and analyzed by using the numerical inverse heat transfer method.

The physical properties of the CT and CS-Cu support, prior to impregnation, are shown in Table 1. The textural properties were obtained from BET surface analysis and indicates the amount of surface area suitable for the reaction to take place, and pore volume indicates the impregnation solution volume required for the IWI method. Notably, because the CS-Cu catalyst is fabricated from the same pellets as the CT, the two catalysts possess the same textural properties (macropores, micropores, pore shapes, and density) within the active portion of the catalyst. Moreover, the CS support retains 89% of the silica content of the non-modified silica pellet. As seen in Table 1, the resulting differences in surface area and pore volume are within experimental error for this measurement. While high surface area is desirable, the 200 m²/g is typical of many FTS catalysts. More important is the large pore diameters, which should be in excess of 10 nm (nanometers) for optimal FTS. Here the diameters are just above this threshold, and the pore volumes of 1.1 m³/g are suitable.

The thermal properties of the silica support and the silica pellet with the copper core are central to this study. As shown in Table 1, the bulk thermal conductivity of the two are equivalent within experimental error; however, they differ significantly in heat capacity. This heat capacity is listed per unit mass and per unit volume and for the purposes of this study, the comparison needs to be made between the volumetric heat capacities, as equivalent volumes of catalyst are used in the FTS runs. The core-shell structure has 4.3 times the heat capacity of the silica structure, which has important ramifications in catalyst performance.

TABLE 1
Physical characterization of the silica support and cores-shell support before impregnated
with Co—Ru catalyst using BET, the bulk thermal conductivity and heat capacity

| | | | | | Average pore | Bulk thermal | Specific heat | Volumetric |
|---|---|---|---|---|---|---|---|---|
| Catalyst | Diameter | Core size | Surface area | Pore volume | diameter | conductivity | capacity | heat capacity |
| support | (mm) | (mm) | (m²/g) | (cm³/g) | (nm) | (W/m-K) | (kJ/Kg-° C.) | (kJ/m³-° C.) |
| silica | 3 | N/A | 210 ^{a} | 1.1 ^{a} | 10.5 ^{a} | 0.12 ± 0.020 | 789 ± 13 | 482 ± 8 |
| core-shell | 3 | 1 | 210 ^{a} | 1.1 ^{a} | 10.5 ^{a} | 0.13 ± 0.021 | 461 ± 27 | 1984 ± 117 |

Note:
^{a} Material properties obtained from Saint-Gobain data sheet of the provided sample in each lot.

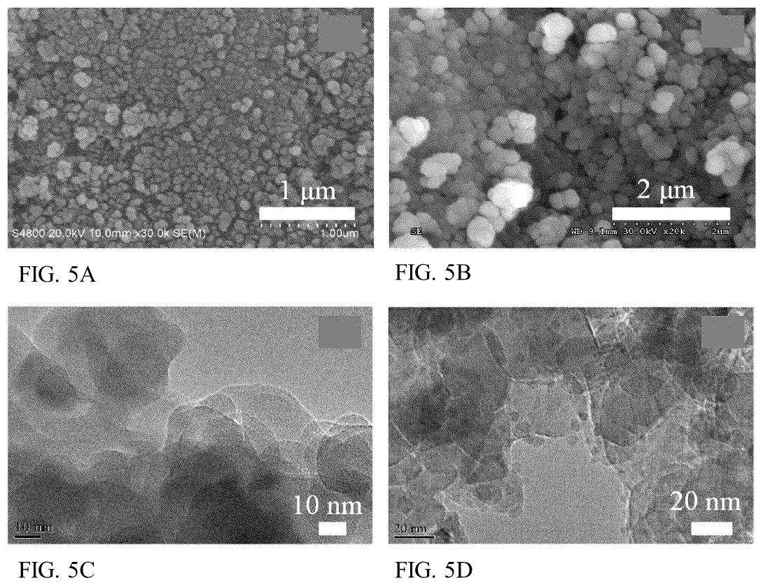

The catalyst supports before and after impregnation were analyzed using SEM and TEM to see the micro and nano-structure of the catalyst before and after impregnation. The SEM images for the silica portion of the silica support is shown in FIG. 5(a) and reveals a surface and bulk composed of partially fused silica spheres ˜120 nm in diameter. After impregnation, calcination, and H₂ reduction the surface is comprised of much large spheroids ranging from 200 nm to 400 nm in diameter, revealing some agglomeration and coating of the silica spheres, as shown in FIG. 5(b). The nanostructure of the unmodified silica was imaged by TEM, as shown in FIG. 5(c), as well as the reduced CS-Cu catalyst (silica powdered and copper removed), as shown in FIG. 5(d). The contrast between the two shows the appearance of a multitude of cobalt-ruthenium islands, 3 to 8 nm in diameter, distributed randomly over the silica surface. There were no appreciable differences between the SEM and TEM images of the CT and CS-Cu catalysts, suggesting the structures, thus far, are analogous.

### Catalyst Activation and Operation

During the initial period in which syngas is introduced into the reactor and the temperature is ramped up to the desired FTS reaction temperature, there is a considerable amount of catalyst ‘reorganization’ prior to achieving a stable reaction. It is not well understood what processes are occurring during this period but items such as change in the crystallite structure and sizes due to the presence of CO, the formation of some CoO and Co₂C are all postulated. Both FCC (face-centered cubic) and HCP (hexagonal close-packed) cobalt crystals are formed and the conditioning may alter this ratio, with the HCP crystallites thought to be more productive FTS catalyst. Moreover, it takes time for the catalyst pores to fill with liquids and heavier hydrocarbons that will dictate the mass transfer steady-state.

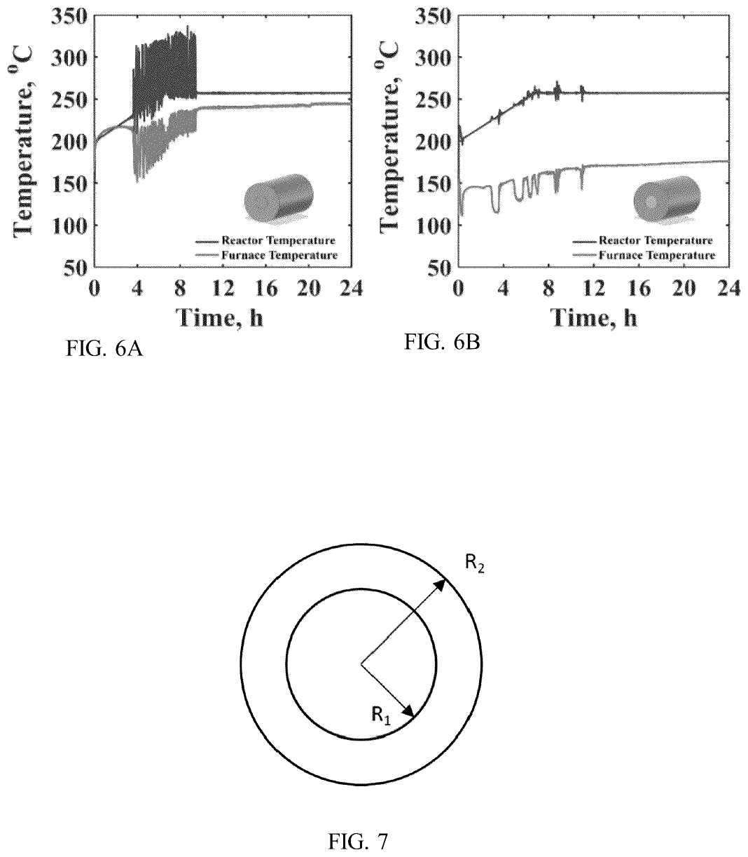

FIG. 6 shows the temperature profiles versus time as measured in the center of the catalyst bed ((Tc) shown in blue trace) and in the middle of the furnace ((Tf) shown in red trace). This profile starts when the feed gas is switched to syngas and the temperature ramp is set to increase from 150 to 255° C. at 0.6° C./min. The furnace is present to heat and maintain the desired reaction temperature during the activation process and later to maintain a constant temperature during FTS. As the FTS reaction is exothermic, it is necessary to moderate the temperature in the catalyst bed by occasionally turning off the oven. As seen in FIG. 6, the temperature profile for both catalysts is not linear as occasional exotherms in the bed cause temperature spikes. In a feedback loop, the oven responds by turning off until the bed cools just beyond the setpoint. However, by the time the bed cools to that point, the oven has cooled and can overshoot the setpoint for Tc, thereby setting off another exotherm in the FTS bed transfer and another spike. While this cycle can be a function of the heat transfer and the feedback loop, it is also a function of the heat capacity of the catalyst bed. Greater heat capacity in the bed would minimize the temperature swings as more thermal energy in any exotherm can be stored in the bed and more heat is available to maintain the temperature in a cooling bed.

Large temperature spikes were observed during the first two days of conditioning and operation of the CT catalyst, as shown in FIG. 6(a), especially when compared to the temperature profile for the CS-Cu catalyst, which is shown in FIG. 6(b). The catalyst bed in the CT reaction experienced temperature jumps of approximately 70° C. (up to 330° C.), whereas the reaction with CS-Cu catalyst had far fewer spikes at much lower magnitudes, never getting above 270° C. The spikes are due to the lag periods between the time when the oven is turned off and the bed temperature jumps due to a local exotherm due to active FTS. The heat transfer between the furnace and catalyst bed is slow relative to the exotherms, thus the feedback mechanism is imperfect. This deficiency, however, has the benefit of revealing the differences in thermal stability of the two catalyst beds during this phase of the FTS reaction, and presumably throughout the reaction. It is noted that the temperature profiles shown in FIG. 6 should be considered representative of the general processes seen in the FTS runs. For a given run, a unique temperature profile with random spikes were observed due to the stochastic nature of when a local exotherm occurs. However, all runs with the CT catalyst showed more frequent and substantially larger temperature spikes than those with CS-Cu catalysts, indicating this is a common feature of the catalyst.

The difference in behavior between the CT and CS-Cu catalyst beds reveals the CS-Cu bed to be far more resistive of large temperature swings due to local exotherms. This thermal stability is a direct consequence of the 4-fold enhancement in volumetric heat capacity for CS-Cu over CT catalysts and demonstrates the basic utility of this approach. The greater volumetric heat capacity of the Cu core acts as a thermal reservoir, storing and releasing heat as needed to dampen temperature swings.

Significantly, the steady-state difference in Te and Tf is much larger for the CS-Cu catalyst over the CT catalyst, at 95° C. versus 18° C., respectively. This is indicative of a more active catalyst at steady-state in the CS-Cu catalyst as indicated by the greater amount of heat generated by the FTS, thus requiring less heat from the furnace. It is believed that the CS-Cu catalyst is more active than the CT catalyst at least in part because of greater thermal protection during the local exotherms. The large temperature spikes are likely to cause catalyst active phase sintering leading to larger less catalytically active metals or deactivation of the catalytic phase. In other words, more of the active catalyst survives the exotherms as these temperature spikes are avoided in the CS-Cu case.

The differences in the temporal responses of the two catalysts to transient temperature variations was modeled computationally. The results obtained from a numerical inverse heat transfer experiment are shown in Table 2. The CT and CS-Cu catalyst showed only a small deviation of the bulk thermal conductivity. As a result of a thick layer of porous SiO₂ dominating over the catalyst support even after the core of the catalyst was replaced with copper, the volume of copper was not high enough to increase the bulk thermal conductivity of the catalyst support. A significant attenuation of the temperature swing was observed for the core shell catalyst. The physical explanation for this effect lies in the presence of the metallic core and its influence on the unsteady flow of heat within the pellet. A theoretical study was performed to reveal the impact of the core properties on the temperature for time varying reaction rates. A linear unsteady heat conduction analysis was performed for the core-shell geometry between SiO₂ catalyst with SiO₂ core in CT (Catalyst 1) and with copper core in CS-Cu(Catalyst 2), the geometry of which is illustrated in FIG. 7. The unsteady thermal energy flow by conduction is governed by the following heat conduction equation:

$$ρC \frac{\partial T}{\partial t} - ∇ \cdot k ∇ T = Q$$

where T is temperature
C is the specific heat capacity
p is the density
k is the thermal conductivity
Q is the volumetric heat source

TABLE 2
The thermal properties of porous silica
(SiO₂) and copper used in the simulation.

| | Thermal properties | |
|---|---|---|
| Material | ρC(J/m³*K) | k(W/m*K) |
| Porous Silica | 1.61E5 | 0.14 |
| (90% porosity) | | |
| Copper | 3.35E6 | 400 |

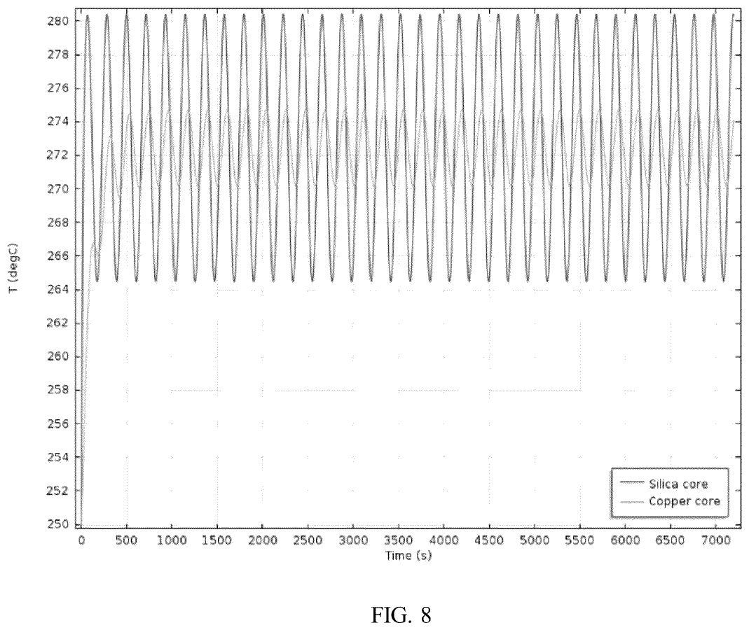

The volumetric heat source is non-zero in the shell and represents the heat power released due to the exothermic reaction. The rate of energy release is directly proportional to the reaction rate. The heat source is zero in the core volume due to the absence of reaction. The equation was solved numerically for two cases. In the first case, the core and shell are porous silica. In the second case, the shell is porous silica while the core is copper. The thermal properties of the material shown in Table 2 and the simulation initial conditions shown in Table 3 were used in the simulation to predict the temperature of Catalysts land 2 during the synthesis. The heat source was assumed to be a periodic function of time with a frequency of approximately 16 cycles per hour. A convective heat flux boundary condition was used with the heat transfer coefficient of 10.0 W/K*m² and fluid temperature of 230° C. The numerical simulation solutions of reaction temperature for both catalyst cases are shown in FIG. 8.

TABLE 3
The FTS simulation initial condition of T and M catalyst.

| Properties | Value |
|---|---|
| R₁, mm | 1.0 |
| R₂, mm | 1.5 |
| Initial temperature at t = 0 s, ° C. | 250 |
| Fluid temperature, ° C. | 230 |
| Q, W/m³ | 1.0E6*(1.0 + 0.2*sin(ω*t)) |
| ω, 1/s | 0.03 |
| Heat transfer coefficient, W/K*m² | 10 |

As shown in FIG. 8, the catalyst with the SiO₂ core showed high-temperature variation as a function of time (ΔT≈15° C.), but the temperature swing was significantly reduced by replacing the SiO₂ core with the copper core. The temperature swing of catalyst replaced with the copper core was reduced to about 5° C. (ΔT≈5° C.).

It should be noted that although both cases have the same geometry and same heat source power, the Cu core case shows a significant reduction in temperature amplitude compared to the Si core case. The physical explanation for this result lies in the large volume specific heat capacity and conductivity of the Cu relative to the Si, as shown in Table 2. The core acts as a thermal reservoir that absorbs heat when the shell exceeds the core temperature and releases heat when the shell drops below the core temperature. High conductivity allows rapid transport of heat energy to and from the reservoir with a low temperature gradient, thus resulting in lower peak temperature during fluctuations in reaction rates. High volume specific heat capacity allows for larger thermal energy storage in a smaller volume, which is beneficial for increases in volume specific reaction productivity. Similar reduction in temperature swings is also observed in the experimental data, as shown in FIG. 6(b), utilizing the Cu core.

### Catalytic Performance

The catalytic performance of the CT and CS-Cu catalyst were compared under identical synthesis conditions. The results are shown in Table 4.

TABLE 4
Fischer-Tropsch synthesis catalytic performance of 16 wt % Co and 1.5 wt % Ru on traditional
SiO₂ catalyst support and modified SiO₂ catalyst support different core.

| 16 wt % Co and 1.5 wt % Ru on SiO₂ support | | | | | |
|---|---|---|---|---|---|
| | | | Modified SiO₂ | Modified SiO₂ | Modified SiO₂ |
| Traditional | Modified SiO₂ | Modified SiO₂ | catalyst support | catalyst support | catalyst support |
| SiO₂ | catalyst support | catalyst support | with 0.7 mm | with 0.9 mm | with hollow |
| support | with Cu core | with Al core | graphite core | graphite core | core |

Products:

| | | | | | | |
|---|---|---|---|---|---|---|
| Oil, g | 18.2 | 23.3 | 13.2 | 16.2 | 20.6 | 13.3 |
| Aqueous phase, g | 69.1 | 73.0 | 106.0 | 89.8 | 88.5 | 58.6 |
| Wax, g | 0.7 | 2 | 0.9 | 0.9 | 0.37 | 3.1 |
| Alcohol, g | 6.9 | 11 | 11 | 11 | 9 | 6 |

Catalytic performance:

| | | | | | | |
|---|---|---|---|---|---|---|
| Overall catalyst productivity, | 0.57 | 0.86 (+51%) | 0.60 (+5%) | 0.59 (+4%) | 0.75 (+32%) | 0.48 (−16%) |
| g_{(product)}/g_{(Co-h)} | | | | | | |
| Oil and wax productivity, | 0.43 | 0.63 (+47%) | 0.34 (−21%) | 0.39 (−9%) | 0.53 (+23%) | 0.35 (−19%) |
| g_{(C5+ product}/g_{(Co-h)} | | | | | | |
| CO conversion, % | 26 | 31 (+19%) | 23 (−12%) | 14 (−46%) | 28 (+8%) | 22 (−15%) |
| C5+ selectivity, % | 52 | 55 (+6%) | 40 (−23%) | 42 (−19%) | 52 (0%) | 45 (−13%) |
| CH₄ selectivity, % | 17 | 12 (−29%) | 19 (+12%) | 18 (+6%) | 15 (−12%) | 20 (+18%) |
| CO₂ selectivity, % | 4 | 2 (−50%) | 4 (0%) | 4 (0%) | 3 (−25%) | 4 (0%) |
| C₂-C₄ selectivity, % | 12 | 9 (−25%) | 13 (+8%) | 13 (+8%) | 11 (−8%) | 14 (+17%) |
| Alcohol selectivity, % | 10 | 15 (+50%) | 6 (−40%) | 6 (−40%) | 6 (−40%) | 6 (−40%) |
| Syngas conversion, % | 54 | 37 (−30%) | 48 (−11%) | 41 (−24%) | 42 (−22%) | 23 (−57%) |

Oil product distribution:

| | | | | | | |
|---|---|---|---|---|---|---|
| Maximum carbon number | C₃₄ | C₂₉ | C₃₃ | C₃₂ | C₂₆ | C₃₂ |
| Isomer, % | 7 | 7 (+0%) | 6 (+14%) | 7 (+0%) | 5 (−29%) | 5 (−29%) |
| n-product (paraffins), % | 78 | 90 (+15%) | 89 (+14%) | 93 (+19%) | 91 (+17%) | 93 (+19%) |
| Olefin, % | 15 | 3 (−80%) | 5 (−67%) | 0 (+100%) | 4 (−73%) | 2 (−87%) |

Physical performance:

| | | | | | | |
|---|---|---|---|---|---|---|
| Bulk thermal conductivity, W/m-K | 0.126 | 0.136 | N/A | N/A | N/A | N/A |

Note:
Synthesis condition: T = 255° C., P = 300 psig, H₂/CO = 2, GHSV = 510 h⁻¹, TOS = 120 h.

The catalysts used in this FTS experiment resulted in 37% syngas conversion for the modified SiO₂ catalyst support with a Cu core and 54% syngas conversion for the traditional SiO₂ supported catalyst. Even though the traditional SiO₂ supported catalyst showed higher syngas conversion, most of the conversion went toward CH₄ selectivity, which was 29% higher than the modified SiO₂ support with Cu core. In addition, the catalytic performance result obtained from the modified SiO₂ support with Cu core showed higher selectivity in the overall catalyst productivity (+51%), % oil and wax selectivity (+47%), and % alcohol selectivity (+50%). The hydrocarbon products collected from the experiment were analyzed and showed that the modified SiO₂ catalyst support with a Cu core showed higher straight-chain hydrocarbon or n-product (+15%) but showed about 80% lower longer chain hydrocarbon or wax product.

Further, the CS-Cu catalysts showed improvement in almost all aspects over the CT catalyst with a 50% improvement in overall catalyst productivity (approximately 0.9 g_{(product)/g(Co-h)} versus 0.6 g_{(product)/g(Co-h)}, respectively), which is to be expected given the greater deactivation experienced by the CT catalysts. (The overall catalyst productivity result includes combined production of oil, wax, alcohol, and light gas (C₂-C₅), excluding methane and carbon dioxide.) At similar CO conversions (31% vs. 26%, respectively), methane selectivity for the CS-Cu catalyst was 12% compared to 17% for the CT catalyst, and olefinic content was considerably lower (3% vs. 15%, respectively), which could be attributed to less CoO present in the CS-Cu catalyst. While the CO₂ selectivity of the CT catalyst was low at 4%, the CS-Cu catalyst was even better at 2%. Co-pellet catalysts are reported to yield as much as 21% CO₂ at higher temperatures (240° C.) in a packed bed reactor. The olefin content dissolved in liquid oil was about 15% by mass of the liquid oil. Note that the FTS reaction was run for 120 hours, where T=0 being when the temperature ramp from 150° C. to activate the catalyst begins. Because some of the liquid products are captured under pressure (hot trap), it could not be discerned how much or what type of product was produced during the activation step, however this represents less than 6% of the time on stream.

Introducing a thermally conductive material like copper in the CS-Cu catalyst clearly affected the catalytic performance but much of this enhancement is likely due to less thermal deactivation due to large thermal swings during activation. Nevertheless, the lower olefinic content and higher C5+ selectivity of the product are both beneficial attributes. It is also likely that some of the difference in performance is realized during regular operation as the more stable bed temperature minimizes changes in temperature and thereby changes in selectivity, which is supported by the lower methane selectivity for the CS-Cu catalyst.

As indicated in Table 4, additional FTS runs were also performed using silica supports with an aluminum core, two different sizes of a graphite core, and also a hollow core. In general, some of these catalysts performed better than the conventional silica support in some areas and thus may be advantageous relative to the silica support, although none of the other tested catalysts performed as well as the modified CS-Cu catalyst, likely because the other tested material have a significantly lower volumetric heat capacity compared to the copper core. However, it is believed that these modified core-shell catalysts, as well as other types of core-shell catalysts, may be advantageous for certain types of reactions other than FTS. Thus, it should be understood by one of skill in the art that any type of core-shell catalyst having a porous shell surrounding a core made of a different material that increases the bulk thermal capacity of the resulting catalyst structure falls within the scope of the present disclosure.

### CONCLUSION

Addition of highly conductive copper wire along the central axis of cylindrical silica pellet catalyst supports imparts a large increase in volumetric heat capacity to the resulting supported catalyst and reveals a remarkable ability to modulate and minimize thermal swings in the FTS reaction, particularly during the initial activation period. The consequence of having a more uniform temperature profile in the catalyst bed and each catalyst pellet is increased productivity, enhanced C5+ selectivity, and less catalyst deactivation. Specifically, CS-Cu catalyst improves catalyst productivity by about 50% at roughly comparable conversion (˜28% CO conversion) with 38% less light gas production. Moreover, olefin content drops from 15% to 3% with the CS-Cu catalyst, indicating greater paraffin selectivity.

The catalysts were also tested to determine the improvement of the bulk thermal conductivity of the catalyst support before and after modification. However, the Cu core inserted in the middle of the catalyst support did not show significant improvement in the bulk thermal conductivity, as shown in Table 4, which indicates that the catalytic improvement came from another factor rather than the bulk thermal conductivity. Hence, the synthesis temperature inside the reactor and the furnace was analyzed to see the effect of the Cu core on synthesis temperature compared to the conventional catalyst, as shown in FIG. 6. As the results show, reactor temperatures for both catalysts started to stabilize around 15 hours after the synthesis started. The traditional SiO₂ supported catalyst showed high fluctuations in both reactor and furnace temperatures after synthesis was activated with the amplitude ΔT≈100° C. The temperature gap between the reactor and the furnace temperature of the traditional catalyst started to converge until they merge, which showed early signs of catalyst deactivation. However, the modified SiO₂ supported catalyst with a Cu core showed only small fluctuations (ΔT≈10° C.) in reactor temperature in the first 15 hours, as shown in FIG. 6(b). Moreover, the temperature gap between the reactor and furnace of the modified SiO₂ catalyst support with a Cu core was rather constant, which may explain the higher catalytic performance when adding the Cu core. In addition, the high thermal capacity of the Cu core worked as a temperature damper for the synthesis by reducing the temperature downward when the exothermic reaction was high and then released heat outward from the core when the reaction started to subside.

Thus, compared to convention catalysts, by replacing the porous interior support with a solid material with high thermal conductivity and heat capacity, such as copper metal, the metal serves as a heat reservoir to either absorb or release heat according to the temperature in the outer layer where the reaction is occurring. This helps to avoid exposing the reaction layer to large temperature swings that may occur during changing flow conditions within the reactor. Thus, the ratio of metal mass to catalyst mass controls the degree of temperature damping. The highly conductive core can also serve to improve the overall bulk thermal conductivity of the packed bed reactor, which allows the diameter of the reactor tube to be increased while still maintaining the desired reaction temperature.

### Heterogeneous Metal Distribution Catalyst

In another aspect, a catalyst having a heterogeneous distribution of active metal catalyst and a method of producing the catalyst are provided. The catalyst comprises a support, which is preferably porous silica or alumina, that is impregnated with an active metal catalyst, such as cobalt and/or ruthenium. The metal catalyst is heterogeneously distributed within pores of the support so that there is a greater concentration of the active metal catalyst near the exterior surface of the support. The catalyst support preferably comprises a plurality of pellets, each of which may have a cylindrical shape or other suitable shape. Each pellet is porous but generally has an exterior surface. A molten form of the metal catalyst is then poured over the pellets to impregnate the catalyst support with active metal catalyst. In one preferred embodiment, the molten catalyst solution is an aqueous solution of cobalt nitrate hexahydrate.

Unlike a conventional incipient wet impregnation technique that uses a volume of solution having a volume that is approximately equal to the pore volume of the catalyst support and that is typically at room temperature, the present method utilizes a solution that is heated above room temperature and also utilizes a volume of solution that is substantially less than the volume used in incipient wet impregnation. In a preferred embodiment, the present method utilizes a volume of solution that is in the range of approximately 10% to 30% by volume of the volume of solution that would typically be utilized for an incipient wet impregnation process. The penetration depth of the solution into the catalyst support may be controlled by adjusting the viscosity of the molten catalyst solution. For instance, the viscosity may be decreased by adding water or increased by adding cellulose or a similar type of polymer in a solution. The present catalyst preparation method results in the active catalyst metals being concentrated in a narrow band at or just below the surface of the catalyst support.

In the case of exothermic reactions, the active catalyst being concentrated at or near the surface allows for heat produced by the reaction to escape from the catalyst support rapidly and efficiently, which will minimize buildup of heat energy within the catalyst support. By minimizing heat buildup, catalyst produced in accordance with the present method also minimizes catalyst deactivation, which reduces the amount of active metals required, thereby reducing the catalyst cost. In addition, by minimizing the temperature of the catalyst support, catalyst produced in accordance with the present method also minimizes the potential for damage to the catalyst support due to thermal stresses and minimizes undesirable products, such as methane and soot in the case of FTS reactions.

The heterogeneous catalyst was prepared by mixing 5 grams of SiO₂ support (surface area of 210 m²/gram and pore volume of 1.5 cm³/gram) with 4.94 grams (16% by weight) of cobalt nitrate (Co(NO₃)₂·6H₂O) melted at 75-90° C. by placing on a hot plate. Molten cobalt nitrate was poured uniformly over the SiO₂ support (˜1 cm bed height). The SiO₂ bed was stirred with a glass rod in order to facilitate even absorption of the molten cobalt nitrate on the SiO₂ support. The sample was then placed in ambient temperature for 2 hours and then dried overnight at 90° C. After drying, the sample was impregnated again with 0.15 grams (1.5% wt) ruthenium chloride (RuCl₃·xH₂O) with a similar technique as described above. The sample was dried again at room temperature and 90° C. overnight. The calcination process then heated the sample at 350° C. with a heating rate 10° C./minute and kept at 350° C. for 4 hours in ambient air in order to form cobalt oxide and ruthenium oxide.

The volume of molten cobalt nitrate utilized was in the range of approximately 10% to 30% of the volume of catalyst solution typically used for an IWI method, which is generally a volume that is about equal to the pore volume of the catalyst support. In the present preparation, a volume of about 1 ml to 2 ml of molten cobalt nitrate was utilized for an amount of catalyst support that would typically require about 7.5 ml of cobalt solution for an IWI method for the same amount of catalyst support. The volume of molten cobalt nitrate utilized in the present preparation was generally a volume sufficient to cover all exterior surfaces of all of the catalyst pellets without a significant excess of molten solution.

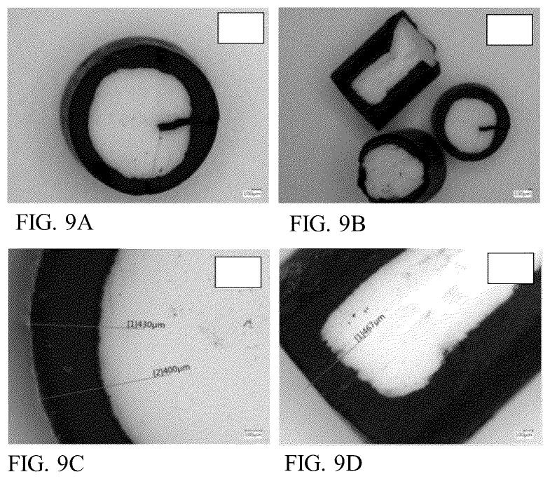

Optical micrographs of the eggshell Ru-Co/SiO₂ catalysts are shown in FIGS. 9(a)-(d). The present melt impregnation technique allows the synthesis of the eggshell catalyst with cobalt and ruthenium located within approximately 0.5 mm of the exterior surface of the pellet, as shown in FIGS. 9(c) and (d). The local metals oxide (cobalt and ruthenium) content in the shell area is about 30%, and about 70% of the silica support contains no metal oxide. The synthesis of thin or thick eggshell can be adjusted by altering the viscosity of the molten cobalt nitrate solution, which may be accomplished by adding water or by adding an organic solution, such as cellulose in an organic solvent, to either decrease or increase the viscosity, respectively, of the cobalt nitrate solution. Altering the viscosity of the solution will then control the penetration depth of the solution into the pores of the support, with the depth of penetration being greater as the viscosity decreases. The volume of liquid added to increase or decrease the viscosity should be minimized in order to minimize the overall volume of the impregnation solution.

It is understood that versions of the present disclosure may come in different forms and embodiments. Additionally, it is understood that one of skill in the art would appreciate these various forms and embodiments as falling within the scope of the invention as disclosed herein.

What is claimed is:

1. A catalyst comprising:
a porous support surrounding a metallic core,
wherein the support is impregnated with an active metal catalyst.

2. The catalyst of claim 1, wherein the support comprises a cylindrical pellet having an opening extending through the pellet along a longitudinal axis of the pellet.

3. The catalyst of claim 1, wherein the metallic core comprises a length of copper wire.

4. The catalyst of claim 1, wherein the metallic core comprises copper or aluminum.

5. The catalyst of claim 1, wherein the support comprises silica, alumina, zirconia, or silicon carbide.

6. The catalyst of claim 1, wherein the metal catalyst comprises cobalt, ruthenium, or a combination of cobalt and ruthenium.

7. A method of producing a catalyst having a heterogeneous distribution of active metal catalyst, said method comprising the steps of:
providing a porous catalyst support, wherein the support comprises a plurality of pellets, wherein each pellet has an exterior surface;
providing a molten metal catalyst;
pouring the molten metal catalyst over the plurality of pellets to impregnate the catalyst support with active metal catalyst;
stirring the plurality of pellets to evenly distribute the molten metal catalyst on the plurality of pellets;
drying the catalyst support;
after drying, calcinating the impregnated catalyst support to produce a catalyst having a heterogeneous distribution of the active metal catalyst within pores of the catalyst support,
wherein there is a greater concentration of the active metal catalyst near the exterior surface of each of the plurality of pellets.

8. The method of claim 7, further comprising the step of adjusting the penetration depth of the molten metal catalyst into the pores of the catalyst support by adjusting the viscosity of the molten metal catalyst.

9. The method of claim 8, wherein the step of adjusting the viscosity of the molten metal catalyst comprises adding water or an organic solution.

10. The method of claim 7, wherein the support comprises silica, alumina, zirconia, or silicon carbide.

11. The method of claim 7, wherein the metal catalyst comprises cobalt, ruthenium, or a combination of cobalt and ruthenium.

12. The method of claim 7, wherein the step of drying the catalyst support comprises drying the catalyst support with an inert gas.

13. The method of claim 12, wherein inert gas is nitrogen.

14. The method of claim 7, wherein the step of calcinating the impregnated catalyst support comprises calcinating the impregnated catalyst support in the presence of oxygen.
